(19) United States
(12) Patent Application Publication
(10) Pub. No.: US 2026/0014854 A1
(43) Pub. Date: Jan. 15, 2026

(54) ROBOTIC PLATFORM WITH A LOW CENTER OF GRAVITY, PARTICULARLY DESIGNED TO MOVE BETWEEN TWO ROWS OF VINES

(71) Applicant: EXEL INDUSTRIES, EPERNAY (FR)

(72) Inventors: Thibault BACLE, LYON (FR); Jocelyn GAUTIER, LYON (FR); Vincent VIDAL, SAINT CYPRIEN (FR)

(73) Assignee: EXEL INDUSTRIES, EPERNAY (FR)

(21) Appl. No.: 19/256,577

(22) Filed: Jul. 1, 2025

(30) Foreign Application Priority Data
Jul. 2, 2024 (FR) 2407174

(51) Int. Cl. B60K 17/342; A01D 46/28; A01D 69/02; B60K 1/02; B60L 50/60; B60L 53/80; F16H 7/08; F16H 7/12

(52) U.S. Cl. CPC B60K 17/342; B60K 1/02; B60L 50/66; B60L 53/80; A01D 46/28; A01D 69/02; B60L 2200/40; F16H 2007/087; F16H 2007/0891; F16H 2007/0897; F16H 7/1263

(57) ABSTRACT

The invention aims at a mobile robotic platform designed to move between two rows of vegetation, vines in particular, comprising four wheels, a hollow chassis defining a chamber, a platform, configured to close the chamber, a propulsion system housed in the chamber and configured to drive the wheels, said system comprising two traction geared motors, each connected to a pair of wheels, each pair being placed on an opposite side of the chassis and facing each other, at least one battery placed in the chassis, two chain systems, each connecting two wheels of the same pair, placed on the same side of the chassis, and each being configured to synchronize the rotation of the wheels on the same side.

### TECHNICAL FIELD

The present invention relates to the field of agricultural machinery and, in particular, the field of autonomous agricultural machinery.

More specifically, the invention relates to a mobile robotic platform designed to move between two rows of vegetation, particularly vines, especially between two narrow rows.

### BACKGROUND

In the wine-growing field, vine rows have a narrow spacing, meaning that two rows of vines are spaced particularly from 0.9 m to 1.30 m and, in some cases, about 1 m, leaving a circulation corridor of about 60 cm wide between two rows. It is known to harvest vine fruits using a straddling system shaking the vine stock to make the fruit fall, and then transfer them to a storage container using a transfer system. The storage container moves parallel to the straddling system in an adjacent row of vines or in adjacent rows of vines, and the transfer system extends between the straddling system and the storage container above the vines. The maintenance of vines, in general, is currently carried out using straddlers equipped with suitable tools.

However, such straddling systems, coupled with storage containers, are bulky and unsuitable for narrow vines. Moreover, these systems do not allow for the collection of grapes in whole bunches, which is particularly mandatory according to the Champagne specifications to obtain the designation of Champagne.

Thus, it is known to manually collect bunches of grapes in narrow vines, which is a constraint in terms of time, as the collection is time-consuming and laborious for the person who must bend down, cut the grape bunch, stand up, and place it in a container, either carried on their back or nearby in the row.

Additionally, there are fruit-picking robots, having a chassis connected to wheels or tracks to allow for movement between rows of plants. On the chassis, a robotic arm is configured to pick the fruit. Furthermore, the chassis can be connected to a cart configured to hold the fruit once picked, as described in the document CN116058175.

However, this type of fruit-picking robot is not suitable for narrow vines, as they are too bulky and unsuitable for uneven terrains with slopes. Indeed, the cart, like the robotic arm, is configured to operate on regular and relatively flat ground.

Thus, the invention aims to solve the aforementioned problems by proposing a robotic platform designed to move between narrow vine rows, adapted to uneven and sloping terrains, allowing for both the collection of whole bunches of grapes and the storage of said bunches of grapes, thereby facilitating, automating, and reducing the time and effort of collecting bunches of grapes in narrow vines.

### SUMMARY

More specifically, the invention concerns a mobile robotic platform designed to move on the ground between two rows of vegetation, particularly vines, extending in length along a longitudinal axis, in width along a transverse axis, and in height along a vertical axis. The platform comprises four wheels for movement, namely two left wheels and two right wheels, with a hollow chassis defining a chamber, connected to the wheels, the left wheels being placed on one side of the chassis and the right wheels being placed on the opposite side of the chassis receiving the left wheels, at least one platform, placed above the chassis chamber, at least one propulsion system configured to drive the four wheels, with this propulsion system being placed in the chassis chamber. The propulsion system comprises at least two traction geared motors, each connected to a pair of wheels, each pair of wheels being placed on an opposite side of the chassis and facing each other, each traction geared motor comprising a motor part housed entirely in the chamber and a reducer part protruding, from the chamber, at least partially outside the chassis to be coupled to a wheel; at least one battery placed in the volume defined by the chassis, under the platform; at least two chain systems, each chain system connecting two wheels placed on the same side of the chassis, each chain system being configured to synchronize the rotation of the wheels on the same side.

The compactness and arrangement of the propulsion system of the robotic platform according to the invention, comprising in particular the traction geared motors, as well as respective motor controllers, one or more batteries, or even a high-level controller, advantageously allows the platform placed above the chassis to barely exceed the top of the wheels vertically, reaching approximately 407 mm from the ground.

The robotic platform is autonomous between the vine rows and allows for the collection and/or storage of fruits, namely bunches of grapes, picked from the vines, for example. Indeed, the wheels allow for robotic platform mobility between the vines, and the chassis, in particular the chassis chamber, allows for housing the wheel propulsion system that enables the movement of the robotic platform. The platform placed above the chassis chamber also allows for the attachment of a storage container for the collected fruit and/or a robotic arm for picking the fruit or maintaining the vines, for example. Moreover, such a propulsion system configuration allows for driving the four wheels of the robotic platform while limiting its bulk and lowering its center of gravity, thus providing good stability of the robotic platform, especially on slopes and inclines. The low center of gravity allows the platform to be at a height easily accessible for a person of normal height, who can, if necessary, place bunches of grapes directly into containers, such as viticultural crates, placed on said platform.

Advantageously, the propulsion system comprises two traction geared motors, and one or two batteries configured to power the traction geared motors, with each of the traction geared motors allowing for the movement of two wheels on the same side of the chassis. In the presence of two batteries, with these also placed facing each other and placed in the chamber.

The traction geared motors comprise, in a conventional manner, a reducer part and a motor part, electric in particular in this case, and interact with bearings to be coupled to the wheels.

With the presence of the two traction geared motors and the one or two associated batteries, on each side, a drive wheel is driven by a motor and drives the other wheel on the same side via a chain system.

According to one embodiment, a traction geared motor is placed at the front of the chamber and drives a front wheel on a first side, left or right, the said front wheel of the first side being integral with a crown itself integral with its hub, and being connected to the rear wheel of the same first side via one of the chain systems, the said rear wheel of the first side being itself integral with its own crown integral with its hub, so as to drive in rotation the said rear wheel of the first side; and a second traction geared motor is placed at the rear of the chamber and drives a rear wheel on a second side, opposite the first side, the said rear wheel of the second side being integral with a crown itself integral with its hub, and being connected to the front wheel of the same second side via the other of the chain systems, the said front wheel of the second side being itself integral with its own crown integral with its hub, so as to drive in rotation the said front wheel of the second side, similarly. In this case, the first traction geared motor, at the front of the chamber, allows for the movement of the left wheels and the second traction geared motor, at the rear of the chamber, allows for the movement of the right wheels. Of course, a reverse arrangement, wherein the motor placed at the front drives the right-side wheels and the motor placed at the rear drives the left side wheels, is perfectly possible.

Advantageously, the crowns are fixed on the traction geared motors and have a bowl shape. Thus, the reducers of the traction geared motors are inside these bowls, with the advantages of compactness and the arrangement of the chain systems, on each side, around the reducers, thus allowing for the application of chain tension between the bearings of the traction geared motors.

The speed control of each side, particularly in a speed range from −7 km/h to +7 km/h, allows for either forward movement, with each side having a speed contributing to forward or reverse movement, each side having a speed contributing to moving backward, or a turn, a speed differential between the sides contributing to establishing a curved trajectory that can reach a turning radius such that the platform turns on itself.

Advantageously, the chain systems are placed outside the chassis relative to each side. The same goes for the crowns.

Advantageously, the at least one battery is housed in a bay. Preferably, two batteries are present, each battery powering the traction geared motors.

Advantageously, each battery is housed in a bay, at the bottom of which a connector is housed. Thus, the batteries electrically power, with a nominal voltage of about 48V, for example, two motor controllers, called low level, which each control a traction geared motor. The batteries can also power a DC/DC converter powering the rest of the onboard electronics at a voltage of about 24V.

Advantageously, the batteries are rackable and removable in particular.

Advantageously, the robotic platform also comprises a high-level controller, for example of the embedded PC type, housed in the chamber and configured to execute navigation software for the robotic platform and to command the motor controllers of the traction geared motors.

The chamber can also house other equipment and sensors, in particular at least one GPS sensor allowing for localization of the robotic platform and thus the guidance thereof in the vines; an Ethernet router allowing for creation of an Ethernet network within the robotic platform; a USB hub; a remote-control receiver for the robotic platform; an inertial sensor to determine the pitch, roll, or yaw of the robotic platform.

Advantageously, the robotic platform comprises two tensioner roller systems, namely a first tensioner roller and a second tensioner roller, the first tensioner roller being interposed between the two left wheels and the second tensioner roller being interposed between the two right wheels, the tensioner roller systems being connected to a respective chain system, with these tensioner roller systems configured to ensure the tension of said chain systems.

Advantageously, the robotic platform comprises at least one fuse holder, said fuse holder being connected to the chassis on one of its longitudinal sides.

Advantageously, the robotic platform comprises at least two cameras, located on the chassis on a first transverse side and on a second transverse side of said chassis.

The cameras thus constitute the vision system of the robotic platform.

Advantageously, the chassis comprises an outer casing enveloping this propulsion system and configured to protect this propulsion system. The robotic platform may also comprise a “bumper,” in other words, a buffer, to ensure safety in case of collision with an obstacle.

Advantageously, the chamber has a maximum width along the transverse axis of 0.40 m, the width of the chamber being equal to about 0.37 m in particular, a maximum length along the longitudinal axis of about 1.10 m, the length of the chamber being equal to about 1.02 m, and a maximum height along the vertical axis of about 0.35 m, the height of the chamber being equal to about 0.32 m in particular.

This chassis width allows for implantation of the wheels within a width of about 60 cm, ensuring the circulation of the robotic platform in narrow vines.

The ground clearance is nevertheless preserved, being between 10 cm and 18 cm in particular, more particularly about 14 cm.

Advantageously, the platform is removable on said chassis to close the chassis chamber, or, on the contrary, leave access to the chassis chamber free.

The chassis chamber in particular allows for housing the wheel drive propulsion system enabling the movement of the robotic platform. Thus, the platform is horizontally above the chamber, preventing access to the chamber.

### BRIEF DESCRIPTION OF THE DRAWINGS

The invention will be better understood by reading the following description, given solely as an example, and referring to the attached drawings, given as non-limiting examples, wherein identical references are given to similar objects and in which:

FIG. 1 is a schematic perspective representation of the robotic platform that is the subject of the invention, showing the chassis on which the platform is placed and the two diagonally opposed masts subjected;

FIG. 2 is a side view of the robotic platform of FIG. 1;

FIG. 3 is a view similar to that of FIG. 1, on which a useful volume, for example, a container, has been added to one of the receiving areas of the platform of the robotic platform;

FIG. 4 is a view similar to that of FIG. 3, on which a second container has been added to the other receiving area of the platform of the robotic platform;

FIG. 5 is a top view of the robotic platform of FIG. 1;

FIG. 6 is a bottom view of the robotic platform of FIG. 1, from which a bottom platform of the robotic platform has been omitted, to make the propulsion system of the robotic platform visible;

FIG. 7 is a perspective representation of the robotic platform of FIG. 1 to which only the chassis, the wheels, and the propulsion system have been kept;

FIG. 8 is a perspective representation of the chassis of the robotic platform of FIG. 1;

FIG. 9 is a perspective view of the robotic platform of FIG. 1, from which the platform has been removed, to make the chassis chamber housing the propulsion system visible;

FIG. 10 is a perspective view of the chassis connected to the propulsion system and the wheels of the robotic platform of FIG. 1;

FIG. 11 is a perspective view of the propulsion system of the robotic platform of FIG. 1;

FIG. 12 is a side view of the propulsion system of FIG. 11; and

FIG. 13 shows a cross-sectional view of the robotic platform according to the invention.

It should be noted that the figures present the invention in detail to enable the invention to be implemented; although not limiting, these figures serve in particular to better define the invention if necessary.

### DETAILED DESCRIPTION OF THE INVENTION

The invention relates to the field of agricultural machinery and, in particular, the field of autonomous agricultural machinery.

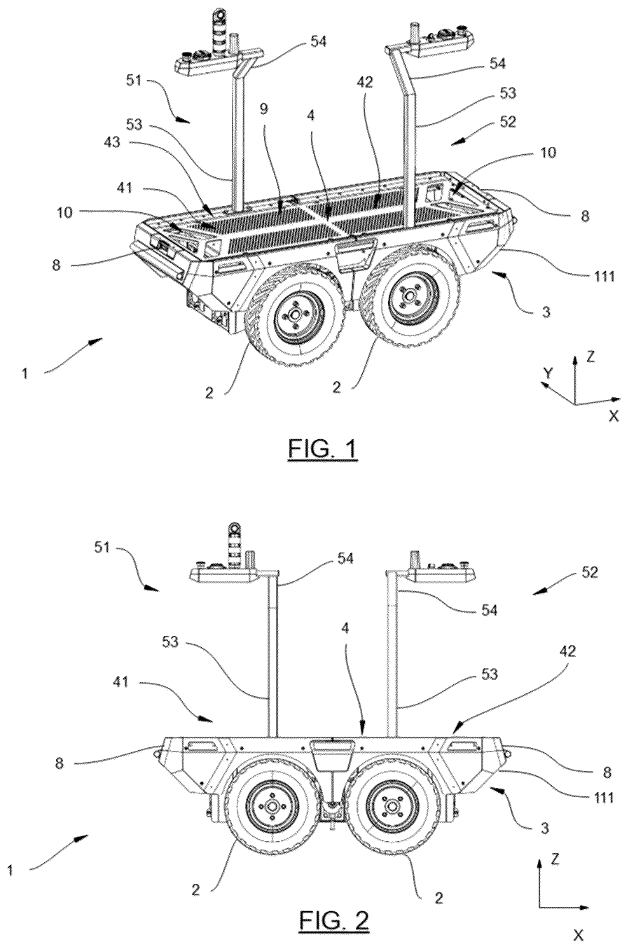

Referring to FIG. 1, the invention concerns a robotic platform 1 in particular. The robotic platform 1 is mobile and designed to move on the ground, between two rows of vegetation, two rows of vines in particular.

In particular, the robotic platform 1 is designed to move between two rows of vines, two rows of narrow vines in particular. It can be autonomous.

Narrow vines are understood as vines whose median axis of the rows is typically spaced about 0.9 m to 1.3 m, for example about 1.2 m, or even 1 m, from each other.

The robotic platform 1 extends in length along a longitudinal axis X, in width along a transverse axis Y, and in height along a vertical axis Z.

The robotic platform 1 comprises four wheels 2. In particular, the robotic platform 1 comprises two left wheels and two right wheels. The wheels 2 allow the mobility of the robotic platform 1 between the vines.

The robotic platform 1 also comprises a chassis 3, at least one platform 4, and at least two masts 51, 52.

Referring to FIGS. 8 and 9, the chassis 3 is hollow and defines a chamber 30. The chassis 3 is connected to the four wheels 2. In particular, the two left wheels are located on the same side of the chassis 3 and the two right wheels are located on the same other side of the chassis 3, opposite the side receiving the left wheels. Referring to FIG. 1, the left wheels are connected to a first transverse side of the chassis 3 and the right wheels are connected to the other transverse side of the chassis 3.

The chamber 30 of the chassis 3 allows for housing a propulsion system 100 of the wheels 2, enabling the mobility of the robotic platform 1 between the vines. The propulsion system comprises traction geared motors and associated power supply batteries in particular, described in detail below.

The chassis 3 has a width along the transverse axis Y of about 0.40 m. The width of the robotic platform 1, considering this chassis and agricultural wheels on each side, thus typically has a width of about 0.60 m, compatible with narrow vines. Indeed, such a width ensures the circulation of the robotic platform 1 in narrow vines.

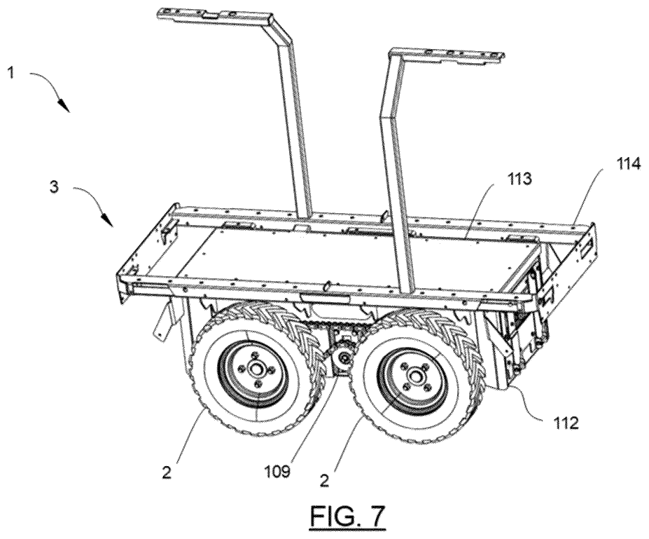

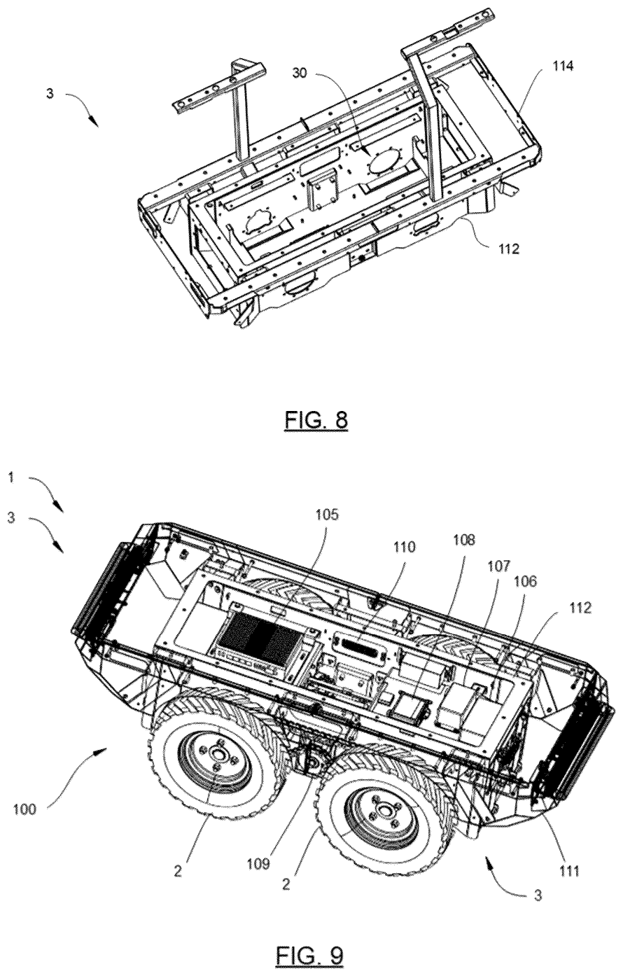

Referring to FIGS. 7 to 9, according to the represented embodiment, the chassis 3 comprises a body 112, a frame 114, and an outer casing 111. The body 112 in particular is represented in FIG. 8. It comprises a steel frame and forms an enclosure. The enclosure defines the chamber 30 inside which the propulsion system 100 is housed. This enclosure is then closed by an upper cover 113 and on this upper cover, the frame 114 is connected. The frame 114 is configured to be the support of the two masts 51, 52 and to extend over the periphery of the body 112. Referring to FIG. 9, the outer casing 111 envelops the body 112 housing the propulsion system 100, thus the outer casing 111 envelops the propulsion system 100. The outer casing 111 thus protects the propulsion system 100.

For safety, the robotic platform may also comprise a “bumper,” in other words, a buffer, to absorb any potential collision with an obstacle. The integration of the “bumper” into the robotic platform 1 is of interest because it allows for access to the batteries while maintaining crossing capabilities, and while keeping a reduced length of said robotic platform 1.

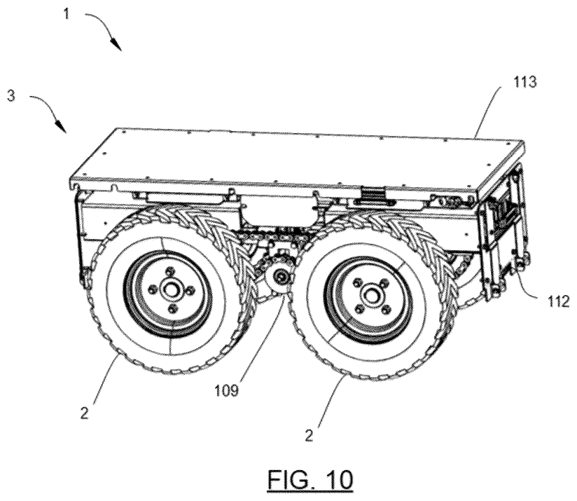

In particular, FIG. 10 allows for visualizing the compactness of the chassis housing the propulsion system of the robotic platform 1 according to the invention, integrating the motorization and transmission, as well as power supply batteries.

Referring to FIG. 1, the platform 4 is removable on the chassis 3 and is configured to be placed above the chamber 30 of the chassis 3.

The chamber can be closed by an upper cover 113, for example, made of sheet metal, and the platform is placed on top. The upper cover 113 ensures the watertight closure of the chamber in particular.

The upper cover 113 of the chamber 30 allows for closing access to the propulsion system 100 of the robotic platform 1. On the contrary, leaving access to the chamber 30 of the chassis 3 free allows for access to the propulsion system 100 and, for example, allows for easy maintenance. The presence of the platform 4 above the chamber does not allow for access to it, while it is possible to access it after removing the platform 4.

In particular, the platform 4 has the shape of a plate extending longitudinally. The platform 4 here defines two receiving areas 41, 42, namely a first receiving area 41 and a second receiving area 42.

In the example represented in the figures, the first receiving area 41 and the second receiving area 42 have the same dimensions.

It is clear that the first receiving area 41 and the second receiving area 42 can have different dimensions.

According to an unrepresented embodiment, the platform 4 may comprise more receiving areas along its length.

As represented in FIGS. 3 and 4, the platform 4 is configured to receive on these receiving areas 41, 42, a container 6 and/or a robot or robotic arm. The container 6, the robot, or the robotic arm are attached to the platform 4. It goes without saying that the container 6, the robot, or the robotic arm mentioned here and in the rest of the description are understood as examples of functional loads that can be received on the platform 4. A “functional load” means a useful load, having a specific function in particular in the context of the robotic platform 1.

Moreover, the robotic platform 1 according to the invention is intended to operate between two rows of vines, in particular. However, it can also be used between two rows of vegetation other than vines. The use of the robotic platform 1 according to the invention is particularly advantageous in the case of vine rows and even more specifically in the case of narrow vines.

Thus, the platform 4 positioned above the chamber 30 allows for placing the container 6 and/or robotic arm in particular, to allow for vine maintenance or harvesting.

Moreover, the platform 4 can interact with fastening units 43. The fastening units 43 are located on each of the longitudinal sides of the chassis 3. The fastening units 43 are configured to allow for attaching each mast 51, 52 to the platform 4 and attaching these containers 6 and/or robots on the platform 4 in the first area 41 and the second area 42 respectively.

In the embodiment represented in the figures, the fastening units 43 may comprise threaded bores, for example, allowing for attaching the container(s) 6 on the platform 4 and the robot(s) or robotic arm on the platform 4 by means of a screw system. Once attached, the container 6 and/or the robot is securely connected to the robotic platform 1 and it falling from the platform 1, even on uneven ground, on slopes, etc., is prevented.

Moreover, through holes 9 can be formed in the first area 41 and/or the second receiving area 42 of the platform 4.

The through holes 9 can help in grasping the platform 4 for placing it. Moreover, these through holes 9 also allow for the drainage of grape juice, if necessary, and preventing the accumulation thereof on the platform 4. Moreover, through openings 10 can be formed in the first area 41 and/or the second receiving area 42 of the platform 4.

The openings 10 allow for grasping the platform 4 for handling it. Thus, through these openings 10, the platform 4 can be placed above the chamber 30 or, conversely, the platform 4 can be removed to open the chamber 30 of the chassis 3.

Referring to FIG. 1, the two masts 51, 52 are connected to the chassis 3. In particular, a first mast 51 protrudes from the chassis 3, vertically, along the Z-axis, in the opposite direction of the wheels 2 and a second mast protrudes from the chassis 3, vertically, along the Z-axis, in the opposite direction of the wheels 2. The first mast 51 and the second mast 52 each protrude from one of the longitudinal sides of the chassis 3.

In particular, the first mast 51 extends in the first receiving area 41 or in the second receiving area 42 of the platform 4 and the second mast 52 extends in the other of the receiving areas 42, 41 of the platform 4. In other words, the first and second masts 51, 52 protrude from the two receiving areas 41, 42 on opposite longitudinal and transverse sides of the chassis 3. The first mast 51 and the second mast 52 are diagonally opposed.

The masts 51, 52 are attached to the platform 4 by its fastening units 43. The fastening units 43 then allow a configuration adaptable to the user.

The arrangement of the masts 51, 52 on the platform 4 allows for access to a first vine from a transverse side of the robotic platform 1 but also access to a second vine from another transverse side of the robotic platform 1. Thus, harvesting and/or maintenance can be done simultaneously on the two vines between which the robotic platform 1 moves, without requiring multiple passes or going back-and-forth. Moreover, the masts 51, 52 protruding from the vine vegetation in height, allow for access to the platform 1 by a user located between the vine rows, directly adjacent to the vine rows between which the robotic platform 1 moves.

Referring to the figures, each mast 51, 52 may have at least one control unit and at least one light indicator configured to indicate the location of the robotic platform 1.

The control unit allows for stopping the robotic platform 1, for example. The user can press an emergency stop button present on the mast 51, 52, for example, causing the complete stop of the platform 1. The light indicator, located at a height relative to the ground on which the robotic platform 1 moves and above the vine vegetation, allows a user to locate the robotic platform 1, even when it is in motion between two rows of vines.

Moreover, each mast 51, 52 has a height corresponding to the average height of a human. Thus, a human can access the mast 51, 52 and by simply raising their arm and pressing the control unit, allow the emergency stop of the platform 1. Moreover, such a mast height 51, 52 allows for clearing the vegetation of antennas located in an upper part of the mast 51, 52, allowing in particular the capture of radio and satellite signals.

According to one embodiment, each mast 51, 52 comprises two portions, namely a first portion 53 and a second portion 54, each first portion 53 protruding vertically along the vertical axis Z of the chassis 3 in the opposite direction to the ground, and thus also opposite the wheels 2 resting on the ground. Each second portion 54 protrudes from the first portion 53 in an inclined manner, towards the platform 4. Each second portion allows for supporting the control unit for each mast 51, 52 in particular.

Referring to FIGS. 3 and 4, the robotic platform 1 can allow for the transport of two containers 6, one container 6 on each of the receiving areas 41, 42 of the platform 4. Such a configuration allows for interaction between the robotic platform 1 and one or more users. Indeed, the user picks the bunches of grapes from the vines and places them in the containers 6, with the robotic platform 1 then taking care of the storage and transport of the bunches picked along the vines.

According to an unrepresented embodiment, a robotic arm can be attached to the first receiving portion 41 of the platform 4 and a container 6 can be attached to the second receiving portion 42 of the platform 4. The robotic arm can, for example, comprise a pruner and/or a gripper, allowing for retrieving the bunches from the vines, then storing them in the container 6. Thus, such a configuration allows for the autonomous picking and transport of bunches of grapes across the entire vine.

According to one embodiment, the robotic arm can be equipped with a gripper enabling grasping containers 6 placed on the ground and transferring them onto the platform 4. Thus, with such a configuration, the robotic platform 1 would allow for collection of containers 6 and then their transport.

According to another unrepresented embodiment, a robotic arm can be attached to the first receiving portion 41 of the platform 4 and another robotic arm can be attached to the second receiving portion 42 of the platform 4. Such a configuration allows for maintenance of two adjacent vines autonomously and simultaneously.

It is clear that multiple configuration combinations are possible and that only a part of them is listed here. Various robotic arms can be envisaged, allowing for harvesting, maintenance, and/or collection of containers 6 associated with another similar or different robotic arm, i.e., presenting other functionalities. Combining any of the possible robotic arms with a container 6 may also be envisaged, to allow a user a variety of tasks and thus best adapt to their needs.

The robotic platform 1 may also comprise at least two cameras 8, located on the chassis 3 on a first transverse side and on a second transverse side. The cameras 8 constitute the vision system of the robotic platform 1.

The propulsion system 100 of the robotic platform, represented in FIGS. 6, 9, 11, and 12 is configured to allow driving the four wheels 2.

Referring to FIG. 6, the propulsion system 100 comprises at least two traction geared motors 101, at least one battery 102, and at least two chain systems 103.

The traction geared motors 101 drive two wheels 2, each placed on an opposite side of the chassis 3. The batteries 102 are placed in the chamber.

Each chain system 103 connects two wheels 2 placed on the same side of the chassis 3. Each chain system 103 is configured to transmit the movement of a wheel 2 driven in motion by the traction geared motor 101 to the wheel 2 to which it is connected.

As represented in FIG. 6, the propulsion system 100 comprises two traction geared motors 101, and two batteries 102 powering the traction geared motors 101.

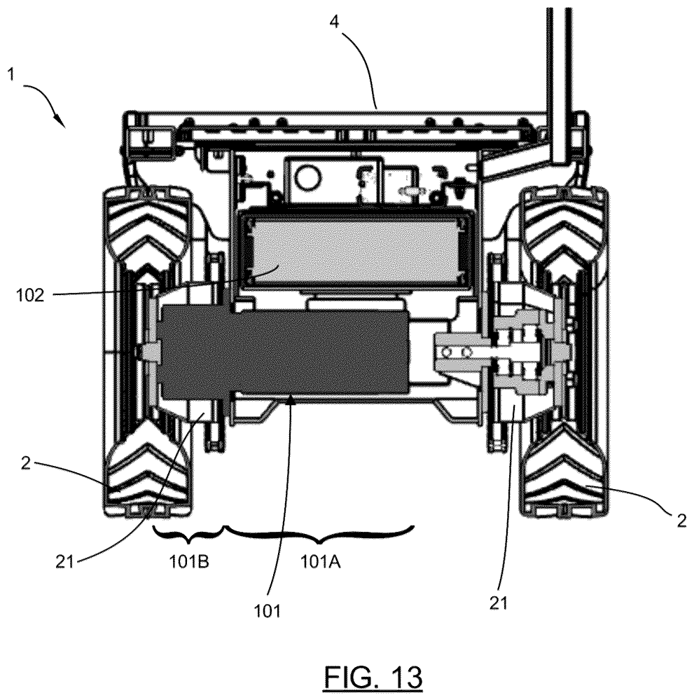

In such an embodiment, each of the traction geared motors 101 allows for the movement of two wheels 2 placed on the same side of the chassis 3. The batteries 102 are placed facing each other, in dedicated bays, under the platform 4. As visible in FIG. 13, the traction geared motors 101 comprise a motor part 101A that is housed in the chamber and a reducer part 101B that protrudes from the chamber, outside the chassis, to drive a wheel 2.

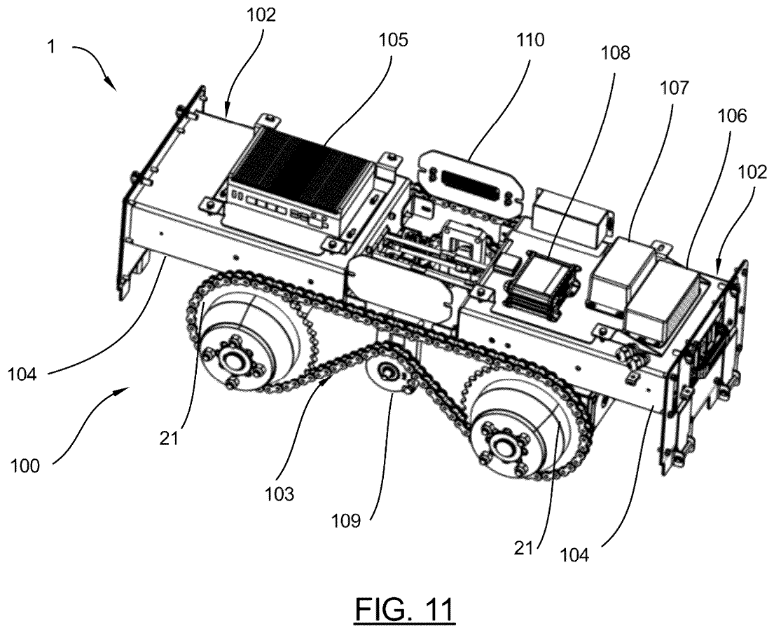

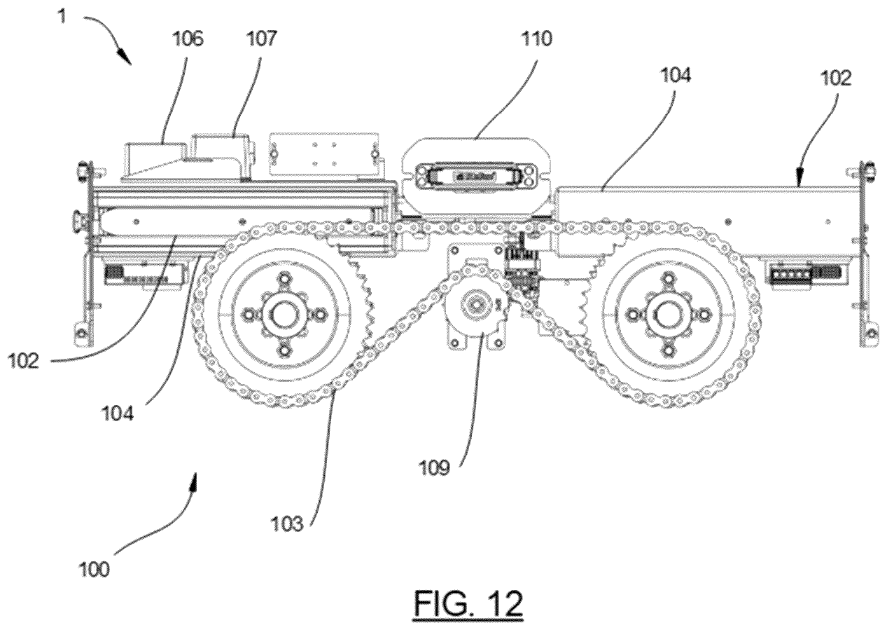

As visible in FIGS. 11 and 12 in particular, the two wheels 2 on the same side of the chassis are thus connected by a chain system 103. On each side, one of the wheels 2, called the drive wheel, is thus rotated by a traction geared motor 101.

Each wheel 2 comprises a hub that is integral with a crown that engages the chain of the chain system 103. The hub and the crown of one of the wheels 2, front or rear, on a respective left or right side, are driven in motion by a traction geared motor 101. The wheel thus driven in motion will synchronously drive the other wheel 2 on the same left or right side as the drive wheel 2, which is driven in motion by the motor 101.

According to the invention, the chain system 103, on each side, is located outside the chamber.

Referring to FIG. 13, the hub of each wheel is in particular integral with a bowl-shaped crown 21. This bowl-shaped crown “caps” the reducer part of the corresponding traction geared motor 101, to which it is fixed, allowing for integrating this reducer part as far outside as possible. In particular, the location of the bowl-shaped crown 21 and the chain system 103 outside the chassis significantly improves the compactness of the chamber.

On each left or right side of the robotic platform 11, the wheel 2 driven in motion by a traction geared motor 101 is connected to said traction geared motor 101; it is the left wheel in FIG. 13. For example, a motor shaft of said traction geared motor 101 is made integral with the bowl-shaped piece 21, which is itself integral with the hub of said wheel 2 and which comprises the crown engaging the chain of the chain system 103.

According to a preferred embodiment, a traction geared motor 101 is placed in the chamber, at the front, and a traction geared motor 101 is placed in the chamber, at the rear. The two traction geared motors 101 are thus placed at the respective front and rear of the chamber, facing each other.

Each traction geared motor 101 is configured to allow for the respective movement of the wheels 2 on one side, left or right, of the chassis.

For example, the traction geared motor 101 located at the front directly drives the wheel 2 located at the front-left of the chassis, which drives the rear-left wheel 2 via the chain system 103. Conversely, in this case, the traction geared motor 101 located at the rear directly drives the wheel 2 located at the rear-right of the chassis, which drives the front-right wheel 2 via the chain system 103.

Referring to FIGS. 11 and 12, the robotic platform 1 comprises two tensioner roller systems 109, namely a first and a second tensioner roller systems 109, ensuring the function of chain tensioners. The first tensioner system 109 is interposed between the two left wheels 2 and the second tensioner system 109 is interposed between the two right wheels 2. The first and second tensioner roller systems 109 are connected to the respective chain system 103 associated with the wheels 2 between which they are interposed. The tensioner roller systems 109 are configured to tension the chain systems 103. The tensioner roller systems 109, on each side, consist of a pinion cooperating with a slide, a screw, and a nut configured to lock the position of the slide in a chain tension adjustment position.

Each traction geared motor 101 is controlled by a motor controller, called “low level.” The low-level controllers receive their instructions via a CAN network. They control and electrically power the traction geared motors 101. In particular, a front motor controller controls the traction geared motor 101 located at the front and a rear motor controller controls the traction geared motor 101 located at the rear. Alternatively, the front motor controller controls the traction geared motor 101 located at the rear and the rear motor controller controls the traction geared motor 101 located at the front.

Each traction geared motor 101, each motor controller, as well as any other energy-consuming device of the robotic platform 1, is powered by electrical energy provided by the batteries 102 in particular. The electrical power delivered by the batteries 102 is distributed to all energy-consuming devices of the robotic platform 1 via an electrical power distribution module. The electrical power distribution module comprises a distribution and electrical connection bar in particular, through which the electrical power delivered by the batteries 102 is distributed.

As energy consumers, the robotic platform 1 may comprise a DC/DC converter in particular, configured to convert the electrical voltage delivered by the batteries 102 to adapt it to the needs of onboard electronic equipment in particular. For example, the electrical batteries 102 deliver a voltage of 48 V and the DC/DC converter converts the electrical energy to bring it to a voltage of 24 V suitable for certain equipment and accessories of onboard electronics, such as a remote-control receiver of the robotic platform 1, a GPS receiver, sensors, etc.

The electrical power delivered by the batteries 102 can also power other unmentioned energy-consuming devices, still via the electrical power distribution module. Moreover, additional batteries placed inside or outside the chassis, above the platform 4 in particular, can also be connected to the power distribution module, either to provide additional electrical energy to the energy-consuming devices of the robotic platform 1, or to power or recharge themselves thanks to the electrical energy provided by the batteries 102 located in the chamber, under the platform 4.

The batteries 102 are removable in particular, to be recharged outside the robotic platform 1, and rackable in dedicated bays provided in the chassis. In particular, these bays can be provided outside the chamber, although located under the platform 4 and inside the volume defined by the chassis. The dedicated bays for the batteries 102 comprise electrical connectors wherein the batteries 102 are intended to be plugged. In particular, the independence of the dedicated bays for the batteries 102 from the chamber allows for managing sealing issues separately. The chamber can thus be capped in a rigorously watertight manner, with the sealing of the chamber unaffected by the removable nature of the batteries 102. In particular, the batteries 102 are elongated in shape, suitable for stacking, and the dedicated bays are of course of a corresponding shape.

Such a configuration of the propulsion system 100 allows for driving the four wheels 2 of the robotic platform 1 while limiting its bulk and lowering its center of gravity, thus providing good stability of the robotic platform 1, on slopes and inclines in particular.

According to one embodiment, the platform 4 of the robotic platform 1 is thus located about 40 cm from the ground, 407 mm from the ground in particular, all comprised. In other words, the platform 4 is just above the top of the wheels 2, which are of the agricultural type. “Agricultural wheel” means standard wheels in the agricultural and viticultural field. These are typically agricultural wheels with a diameter of about 40 cm, configured to be inflated at low pressure, for example at 0.8 bar, and to support loads of about 160 kg per tire at 15 km/h. Such agricultural wheels are particularly suitable for agricultural use, in viticultural plots in particular, as they minimize soil compaction and provide good traction and crossing performance. Due to its reduced length and ground clearance of about 14 cm, the robotic platform 1 is able to cross classic obstacles in the agricultural environment, viticultural in particular, such as bumps of 10 cm in height, at a speed of 7 km/h. Moreover, the dimensions of the robotic platform 1 and in particular of the chassis are adapted to cross slope changes, in other words, crests, common in viticultural plots, ruts, etc.

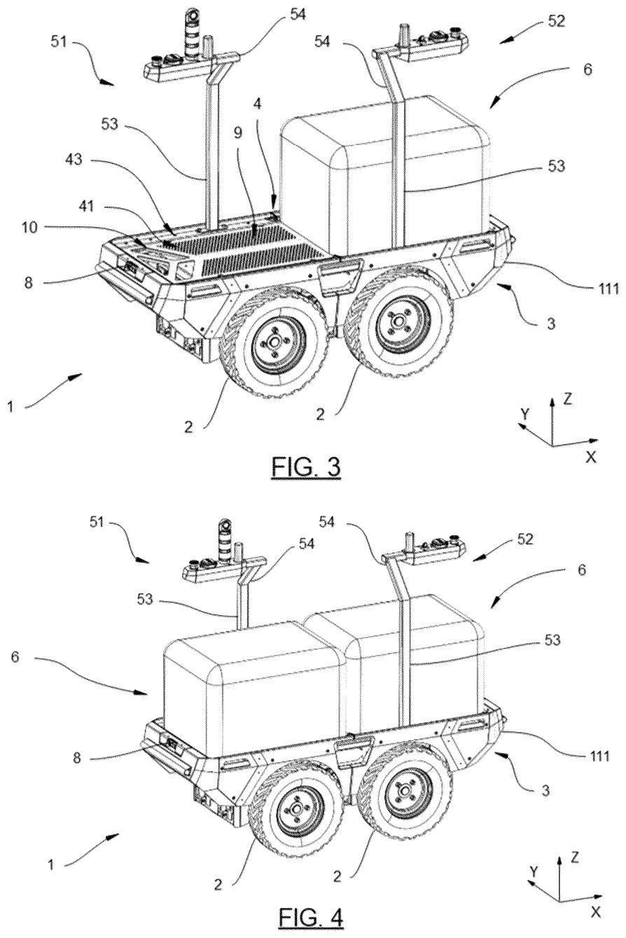

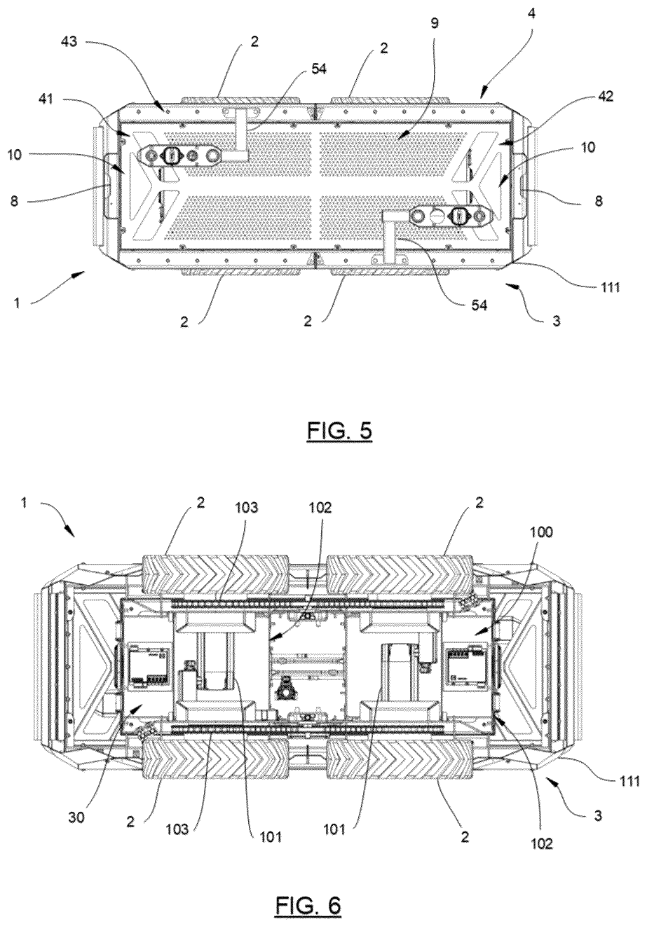

In particular, referring to FIG. 2, a section of the robotic platform 1 without masts, seen from the side, fits roughly into a trapezoid whose long side, at the top, represents the length of the platform 4, about 1.34 m according to the already mentioned embodiment, with a chassis length, corresponding roughly to the length of the chamber, of about 1.02 m. This length of the platform 4 allows for juxtaposing two viticultural crates in particular. The short side of the trapezoid corresponds more or less to the footprint of the robotic platform, i.e., the distance between the front of the front wheel and the rear of the rear wheel. The angle formed at the front and rear by joining the long side and the short side thus defined is adapted to crossing the already mentioned obstacles, as well as the slope changes common in viticultural plots.

With the presence of the two motors 101 and the two associated batteries 102, the wheels 2 on a first longitudinal side, which can be qualified as the front wheels of the robotic platform 1, can be drive wheels and allow driving the other two wheels 2, which can be qualified as the rear wheels of the robotic platform 1.

Conversely, the wheels 2 on the second longitudinal side of the platform 1, the rear wheels, can also be drive wheels and allow driving the other two wheels 2, the front wheels. Thus, the robotic platform 1 can circulate between the vines, in one direction or another, selectively. In other words, the robotic platform 1 can move forward, or conversely backward between the two rows of vines, depending on the user's need.

Referring to FIG. 9, the batteries 102 are housed in a respective bay 104.

The robotic platform 1 also comprises a high-level controller 105, of the embedded PC type for example, housed in the chamber and configured to execute navigation software for the robotic platform and to command the motor controllers of the traction geared motors 101.

Depending on the chosen configuration, the chamber can also integrate an input-output module connected to a CAN network of the robotic platform 1.

A GPS box 106, a remote-control receiver 107 (for remote control of the robotic platform 1), and an Ethernet router 108 can also be integrated into the chamber and powered by electrical energy from the batteries 102, in particular, via a DC/DC converter, if necessary, as previously described. Similarly, the chamber can also house a USB hub or even an inertial sensor allowing measuring the roll, pitch, or yaw of the robotic platform 1.

The GPS box 106 allows for localization of the robotic platform 1 and thus its guidance in the vines. The Ethernet router 108 allows for creating an Ethernet network within the robotic platform 1, for example.

All the aforementioned equipment, optional or not, as well as the electrical power distribution module, the motor controllers that control the traction geared motors, etc. are commanded from the high-level controller 105 as necessary.

According to one embodiment, the robotic platform 1 also comprises an electrical interface comprising electrical connectors intended to power equipment placed on the platform, such as a robot or a robotic arm. For example, these electrical connectors are flush with the upper face of the chamber and allow electrically connecting such electrical equipment through the cover. The electrical power is then provided by the batteries 102 placed under the platform 4. Such electrical connectors also allow for connecting additional batteries outside the chassis, if necessary.

The robotic platform 1 may also comprise at least one fuse holder 110, the fuse holder 110 being connected to the chassis 3 on one of its longitudinal sides.

Thus, the robotic platform 1 of the invention with its low center of gravity is adapted to uneven and sloping terrains and allows for both the collection of whole bunches of grapes and the storage of said bunches of grapes, thereby facilitating, automating, and reducing the time and effort of collecting bunches of grapes in narrow vines.

It should also be noted that the invention is not limited to the embodiments described above. It will indeed appear to the skilled person that various modifications can be made to the embodiment described above, in light of the teaching that has just been disclosed.

In the detailed presentation of the invention made above, the terms used should not be interpreted as limiting the invention to the embodiment presented in this description, but should be interpreted to include all equivalents whose provision is within the reach of the skilled person by applying their general knowledge to the implementation of the teaching just disclosed.

1. A mobile robotic platform designed to move on the ground between two rows of vegetation, vines in particular, extending in length along a longitudinal axis, in width along a transverse axis, and in height along a vertical axis, said platform comprising:
four wheels, namely two left wheels and two right wheels;
a hollow chassis defining a chamber, connected to the wheels, the left wheels being placed on the same side of the chassis and the right wheels being placed on the opposite side of the chassis to the side receiving the left wheels;
at least one platform, placed above the chamber of the chassis,
at least one propulsion system configured to drive the four wheels, said propulsion system being placed in the chamber of the chassis;
said propulsion system comprising:
at least two traction geared motors, each connected to a pair of wheels, each pair of wheels being placed on an opposite side of the chassis facing each other, each traction geared motor comprising a motor part housed entirely in the chamber and a reducer part protruding, from the chamber, at least partially outside the chassis to be coupled to a wheel;
at least one battery placed in the chassis, under the platform;
at least two chain systems, each chain system connecting two wheels placed on the same side of the chassis, each chain system being configured to synchronize the rotation of the wheels on the same side.

2. The robotic platform according to claim 1, wherein said propulsion system comprises two traction geared motors, and one or two batteries configured to power the traction geared motors, each of the traction geared motors allowing the movement of two wheels on the same side of the chassis.

3. The robotic platform according to claim 1, wherein the chain systems are placed outside the chassis relative to each side.

4. The robotic platform according to claim 1, wherein a traction geared motor is placed at the front of the chamber and drives a front wheel on a first side, left or right, the said front wheel of the first side being integral with a crown itself integral with its hub, and being connected to the rear wheel of the same first side via one of the chain systems, the said rear wheel of the first side being itself integral with its own crown integral with its hub, so as to drive in rotation the said rear wheel of the first side; and a second traction geared motor is placed at the rear of the chamber and drives a rear wheel on a second side, opposite the first side, the said rear wheel of the second side being integral with a crown itself integral with its hub, and being connected to the front wheel of the same second side via the other of the chain systems, the said front wheel of the second side being itself integral with its own crown integral with its hub, so as to drive in rotation the said front wheel of the second side.

5. The robotic platform according to claim 1, wherein the at least one battery is housed in a respective bay, said at least one battery being rackable in the bay and removable.

6. The robotic platform according to claim 1, comprising two tensioner roller systems, namely a first pinion and a second pinion, the first pinion being interposed between the two left wheels and the second pinion being interposed between the two right wheels, the tensioner roller systems being connected to a respective chain system, said tensioner roller systems being configured to tension said chain systems.

7. The robotic platform according to claim 1, wherein the chassis also houses a GPS box, a motor controller for each motor, a main controller, an Ethernet router, an inertial sensor.

8. The robotic platform according to claim 1, wherein the chamber has a maximum width along the transverse axis of 0.40 m, the width of the chamber being equal to about 0.37 m in particular, a maximum length along the longitudinal axis of about 1.10 m, the length of the chamber being equal to about 1.02 m, and a maximum height along the vertical axis of about 0.35 m, the height of the chamber being equal to about 0.32 m in particular.

9. The robotic platform according to claim 8, having a ground clearance of about 0.14 m.

10. The robotic platform according to claim 1, wherein the platform is removable on said chassis.
